(19) United States
(12) Patent Application Publication
(10) Pub. No.: US 2007/0168515 A1
(43) Pub. Date: Jul. 19, 2007

(54) System and method of controlling removable media inventory

(75) Inventors: Mark J. Hamzy, Round Rock, TX (US); Johnny Meng-Han Shieh, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation

(21) Appl. No.: 11/334,699

(22) Filed: Jan. 18, 2006

(51) Int. Cl. G06F 15/173

(52) U.S. Cl. 709/226

(57) ABSTRACT

A method, system, and computer-usable medium for controlling removable media inventory. A request for corrective data to be combined with data stored on a removable medium to enable successful processing of the data stored on the removable medium is received from a media device. Then, an identification and flaw assessment of the removable medium is retrieved from the media device. Based on the identification, a server checks if a database entry exists for a class of removable media for which the removable medium is a member. When the database entry exists, the server evaluates if the class of removable media has exceeded a predetermined damage threshold. If the class of removable media exceeds the predetermined damage threshold, the server determines a quantity of removable media of the class of removable media for future procurement.

### BACKGROUND OF THE INVENTION

1. Technical Field

The present invention relates in general to the field of networked data processing systems. More particularly, the present invention relates to the field of organizing inventory of removable media utilizing networked data processing systems.

2. Description of the Related Art

Personal media players have increased in popularity in the last decade. One of the first personal media players was a video cassette recorder (VCR). However, the advent of the digital video disc (DVD) and personal video recorder (PVR) has increased the quality of media playback and reduced the costs associated with personal media players.

A rapidly growing segment of the personal media business is mail-order DVD rentals via services such as Netflix™. These services typically allow a user to indicate a collection of titles that he or she wishes to view. The service provider parses the list and periodically sends out selected DVD titles through the mail to the user. When the user has finished viewing the DVD, the user places the DVD back in the mail to be returned to the service provider.

DVDs eventually develop physical flaws due to multiple users mishandling the discs. Typically, the mail-order DVD rental services allow the recipient of a flawed DVD to indicate online or on the return envelope that the DVD contains flaws. Once the flawed disc is received by the service provider, a new disc is automatically sent to the user.

There are several disadvantages of the current mail-order DVD rental business model. Because the DVD must be returned to the service provider, the user must wait for the new DVD to arrive before he or she can view the movie. The small costs associated with returning flawed DVDs eventually become prohibitive as the DVDs are handled by more users. For example, some DVDs with minor flaws will be consistently returned (adding to mail costs) until they are removed from distribution. The error correction capabilities of different models of DVD players vary widely. Thus, DVDs with slight flaws might be successfully processed by some models but not others, which results in increased mail costs for returned discs. These returned discs might be unnecessarily replaced because they might be playable on some players but not others due to the vast range of error correction capacities of various DVD players. Also, there is a need for a system and method of controlling an inventory of removable media when some of the removable media handled by users become damaged due to mishandling or overuse.

### SUMMARY OF THE INVENTION

The present invention includes a method, system, and computer-usable medium for controlling removable media inventory. A request for corrective data to be combined with data stored on a removable medium to enable successful processing of the data stored on the removable medium is received from a media device. Then, an identification and flaw assessment of the removable medium is retrieved from the media device. Based on the identification, a server checks if a database entry exists for a class of removable media for which the removable medium is a member. When the database entry exists, the server evaluates if the class of removable media has exceeded a predetermined damage threshold. If the class of removable media exceeds the predetermined damage threshold, the server determines a quantity of removable media of the class of removable media for future procurement.

The above-mentioned features, as well as additional objectives, features, and advantages or the present invention will become apparent in the following detailed written description.

### BRIEF DESCRIPTION OF THE FIGURES

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram illustrating an exemplary network in which a preferred embodiment of the present invention may be implemented;

FIG. 2 is a block diagram depicting an exemplary media device in which a preferred embodiment of the present invention may be implemented;

FIG. 3 is a block diagram illustrating an exemplary server in which a preferred embodiment of the present invention may be implemented;

FIG. 4 is a high-level logical flowchart depicting an exemplary method of utilizing a network to correct flawed media data according to a preferred embodiment of the present invention; and

FIG. 5 is a high-level logical flowchart illustrating an exemplary method of controlling removable media inventory according to a preferred embodiment of the present invention.

### DETAILED DESCRIPTION OF THE PREFERRED EMBODIMENT

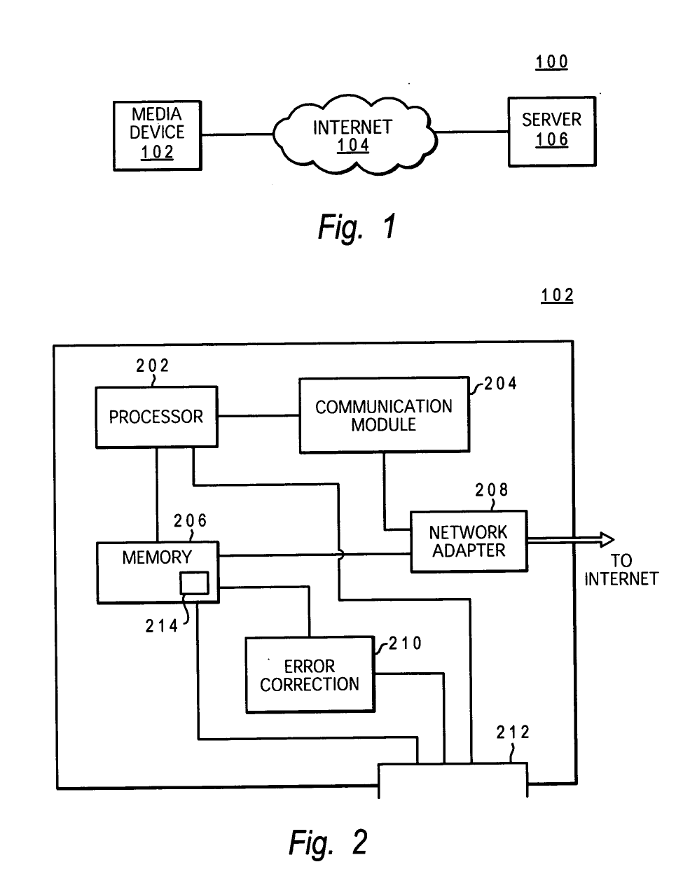

Referring now to the figures, and in particular, FIG. 1, there is illustrated a block diagram depicting an exemplary network 100 in which a preferred embodiment of the present invention may be implemented. As illustrated, network 100 includes media device 102, which is discussed herein in more detail in conjunction with FIG. 2. Media device 102 utilizes a network adapter 208 and a communication module 204, as illustrated in FIG. 2, to connect to server 106 via Internet 104.

With reference to FIG. 2, there is depicted a more detailed block diagram illustrating an exemplary media device 102 in which a preferred embodiment of the present invention may be implemented. As illustrated, media device 102 includes a processor 202, communication module 204, memory 206, network adapter 208, error correction module 210, and removable media interface 212. Media device 102 can be implemented as any type of media player and/or recorder, including but not limited to, a DVD, CD, or flash memory player.

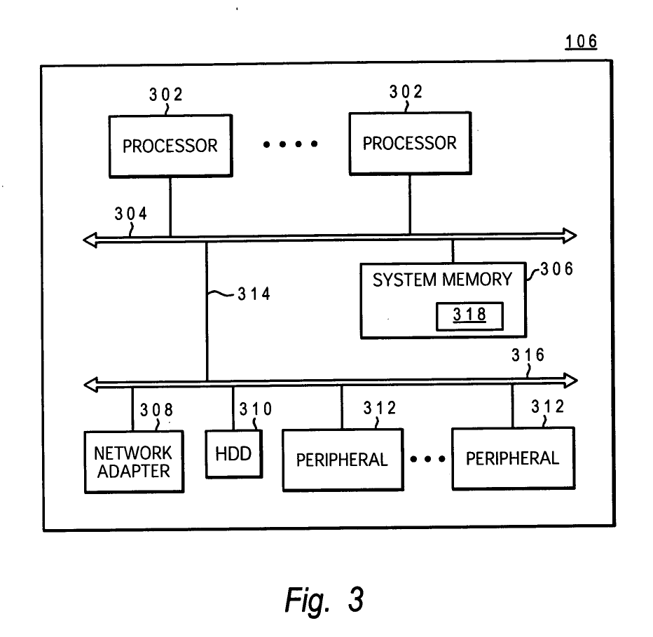

During operation, the user places a removable medium (e.g., DVD, CD, flash memory, etc.) into removable media interface 212. Processor 202 begins processing the data stored on the removable medium. Error correction module 210 examines the removable medium for errors. If the number or severity of errors on the removable medium exceed a predetermined threshold, processor 202, in conjunction with communication module 204 and network adapter 208 query a server 106 (FIGS. 1 and 3) for correction data to enable successful processing of the data stored on the removable medium. Server 106 tailors the correction data to be sent to media device 102 depending on a variety of factors. For example, if server 106 determines that the connection established with media device 102 is a low-speed (e.g., dial-up) connection, checksum data for correcting damaged bits might be sent as opposed to replacement data for the damaged areas of the removable medium. Replacement data (e.g., entire chapters on a DVD) might be sent if server 106 and media device 102 have established a high-speed (e.g., broadband) connection. The correction data is stored in memory 206. In a preferred embodiment of the present invention, a user may set a collection of user preferences 214 that determine the type of correction data requested by media device 102. For example, even if the user has access to a high-speed connection, he or she may decide that the time required to receive the replacement data, as opposed to checksum data, is prohibitive. The user can request that media device 102 only request checksum data in the event of detecting a damaged removable medium.

If processor 202 has received checksum data as correction data from server 106, the correction data is streamed with the data stored on the removable medium during processing by processor 202 for on-the-fly corrections. However, if processor 202 has received replacement data as correction data, the correction data is merged with the original data stored on the removable medium. Therefore, during processing, when processor 202 reaches a flawed area of removable medium where undamaged data cannot be retrieved, processor 202 accesses the merged data stored in memory 206.

Those with skill in this art will appreciate that a preferred embodiment of the present invention may utilize any method of error correction to stream or merge the retrieved correction data with the data stored on the removable medium. An examples of an error correction algorithm well-known in the art is the Error Correction Code (ECC) algorithm which enables damaged bits within data to be repaired with checksum information. When data correction is needed, the missing or incomplete data needed to correct the physical flaws on the removable medium are generated in a list. Media device 102 contacts server 106 (which may be a computer system operated by the removable medium supplier) to retrieve the needed correction data.

Server 106 may also tailor the correction data sent to media device 102 depending on a variety of factors including, but not limited to: the connection speed established between server 106 and media device 102, the number and severity of errors found on the removable medium, etc. For example, if server 106 has determined that the connection established with media device 102 is a low-speed connection such as dial-up access, server 106 may opt to send only checksum or error correction data to correct damaged bits on the removable medium.

As previously discussed, a user may set a collection of user preferences 214 that determine the type of correction data requested by media device 102. This collection of user preferences 214 may be set by the user by accessing his or her respective user account on server 106 via the internet or locally set the collection of user preferences 214 via an interface located on media device 102. Server 106 may parse this collection of user preferences 214 and send the correction data in the user-requested form (e.g., checksum or replacement data). Server 106 may also send information to media device 106 indicating to the user a projected time required to correct the damaged data. Media device 106 can query the user, inquiring whether the projected time required to correct the damaged data is acceptable. If not, the user may request via media device 106 a new removable medium to be sent. Another option the user may select is the extent of the correction depending on the amount of time the user is willing to wait. For example, if the user wants high-quality correction (e.g., complete replacement of damaged data) and is willing to wait the required time, the user can select a “high-quality correction” option. If the user wants to forgo a high-quality correction because he or she would rather view the movie sooner, the user can select the “low-quality correction” option, which usually involves a request of checksum data for “on-the-fly” corrections.

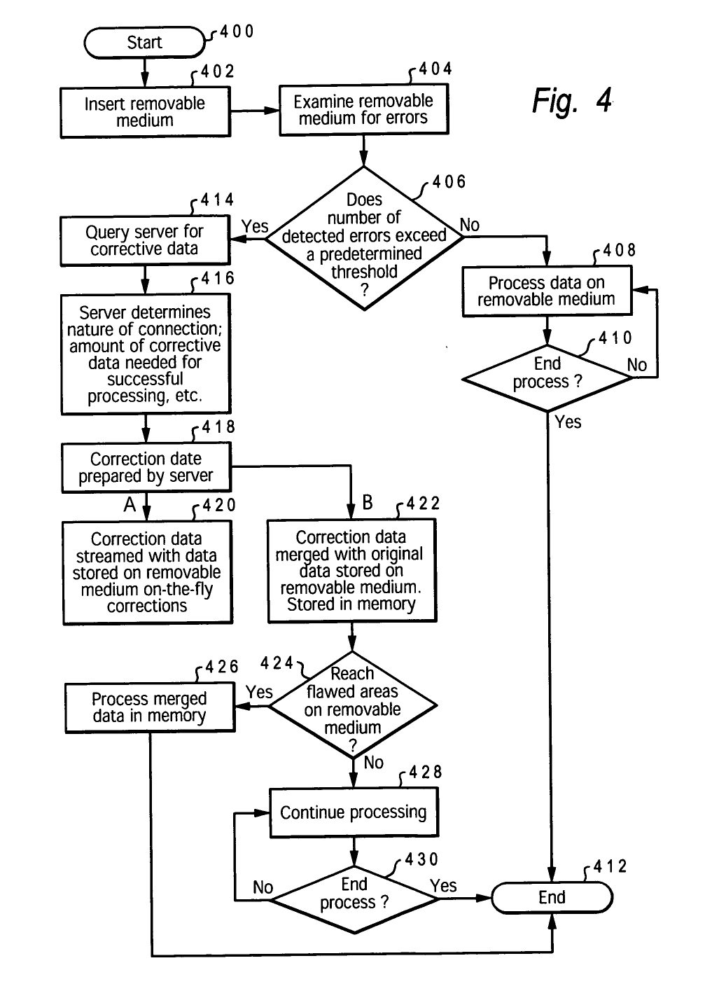

As discussed herein in more detail in conjunction with FIG. 4, checksum or error correction data can be combined with data stored on the removable medium for on-the-fly data corrections during processing. However, there are times, especially when there are a large number of detected errors on the removable medium and the connection established with media device 102 is a high-speed (e.g., broadband) connection, server 106 may opt to send data that replaces the parts of the data stored on the removable medium that is damaged by physical defects. This data would be stored in memory 206 of media device 102. During processing of the data stored in the removable medium, processor 202 may encounter areas on the removable medium that are damaged due to physical defects. Instead of correcting the data stored in the damaged areas via checksum and correction data, processor 202 processes the downloaded replacement data from memory 206. This reduces the processing requirements on processor 202, as compared to a real-time, on-the-fly correction of damaged data.

FIG. 3 is a block diagram illustrating an exemplary server 106 in which a preferred embodiment of the present invention may be implemented. As illustrated, server 106 includes at least one processor 302, which is coupled to system memory 306 via system interconnect 304. System memory 306 also includes a correction data module 318, which determines the character of the correction data to be sent to fulfill a correction data request from a media device 102. For example, correction data module 318 may determine that checksum data utilized for on-the-fly correction of damaged bits may be more appropriate for a particular correction data request. In other situations, correction data module 318 may determine that replacement data (e.g., entire chapters on a DVD) might be more feasible as correction data. Correction data module 318 considers a variety of factors, such as: speed of connection between media device 102 and server 106, severity of damage to the particular removable medium, etc.

Mezzanine interconnect 314 couples system interconnect 304 to peripheral interconnect 316. Those with skill in this art will appreciate that peripheral interconnect 316 may be implemented as any type of peripheral interconnect including, but not limited to, peripheral component interconnect (PCI), accelerated graphics port (AGP) and small computer system interface (SCSI) buses. Coupled to peripheral interconnect 316 is a network adapter 308, hard disk drive (HDD) 310, and a collection of peripherals 312. Network adapter 308 couples server 106 to Internet 104 and allows server 106 to fulfill correction data requests from media device 102, as discussed herein in more detail in conjunction with FIG. 4. System memory 306 and hard disk drive (HDD) 310 store a collection of correction data that may be tailored to each unique correction data request.

FIG. 4 is a high-level logical flowchart diagram illustrating an exemplary method of utilizing a network to correct flawed media data according to a preferred embodiment of the present invention. The process begins at step 400 and proceeds to step 402, which illustrates a user inserting a removable medium into removable media interface 212 of media device 102. The process proceeds to step 404, which depicts processor 202 and error correction module 210 examining the removable medium for physical errors. As previously discussed, these physical errors can include, but are not limited to, scratches on a DVD or CD disc due to user mishandling, or physical errors on tape or flash media.

The process continues to step 406, which illustrates processor 202 determining whether the number of detected errors on the removable medium exceeds a predetermined threshold. This predetermined threshold of errors may be varied by the manufacturer of media device 102 via system firmware stored in memory 206, set via user-defined settings, or any other method. If processor 202 determines that the number of detected errors on the removable medium does not exceed a predetermined threshold, the process proceeds to step 408, which depicts processor 202 processing the data stored on the removable medium. The process continues to step 410, which illustrates a determination made as to whether processor 202 has completed processing the data stored on the removable medium. If processor 202 has not completed processing the data stored on the removable medium, the process returns to step 408. However, if processor 202 has completed processing the data stored on the removable medium, the process proceeds to step 412, which illustrates the process ending.

Returning to step 406, if processor 202 determines that the number of detected errors on the removable medium exceeds a predetermined threshold, the process proceeds to step 414, which illustrates media device 102 querying server 106 via communication module 204 and network adapter 208 for correction data.

The process continues to step 416, which depicts correction data module 318 of server 106 tailoring the correction data to be sent to requesting media device 102 by considering a variety of factors including, but not limited to: the connection speed established between server 106 and media device 102, the number and severity of errors found on the removable medium, and user settings 214 etc, as previously discussed. As illustrated by step 418, processor 302 of server 106 prepares the correction data to be sent to media device 102 via the factors discussed in conjunction with step 416. If correction data module 318 of server 106 determines that checksum data should be sent, the process proceeds to step 420, which illustrates correction data streamed with data stored on removable medium for on-the-fly corrections during processing. The process then ends, as illustrated by step 412. Returning to step 418, if server 106 determines that replacement correction data should be sent to media device 102, the process proceeds to step 422, which illustrates correction data being merged with original data stored on removable medium and stored in memory 206.

The process then proceeds to step 424, which illustrates processor 202 determining whether the flawed areas of the removable medium have been reached during processing of the data. If processor 202 determines that the flawed areas of the removable medium have been reached during processing, the process proceeds to step 426, which illustrates processor 202 processing the merged data stored in memory 206. The process then ends, as illustrated by step 412. However, if processor 202 determines that the flawed areas of the removable medium have not been reached during processing, the process continues to step 428, which depicts processor 202 continue processing the data stored on the removable medium.

The process then continues to step 430, which illustrates processor 202 determining whether the processing of the data has ended. If the data processing has not ended, the process returns to step 428. However, if processor 202 has determined that the process has ended, the process terminates at step 412, which depicts the process ending.

As disclosed, present invention includes a system and method of utilizing a network to correct flawed media data. The media device includes a processor, a memory, a network adapter, a removable media interface, and error-correction module, and a communication module. The network device enables the media device to connect to the network and server. The removable media interface enables a user to couple a removable medium to the media device. After a user inserts a removable medium into the removable media interface, the processor and error-correction module examines the removable medium for physical errors. If the number of detected errors exceeds a predetermined threshold, the media device, via the network adapter and the communication module, queries a server for correction data. This correction data may be utilized by the media device to enable successful processing of the data stored on the removable medium.

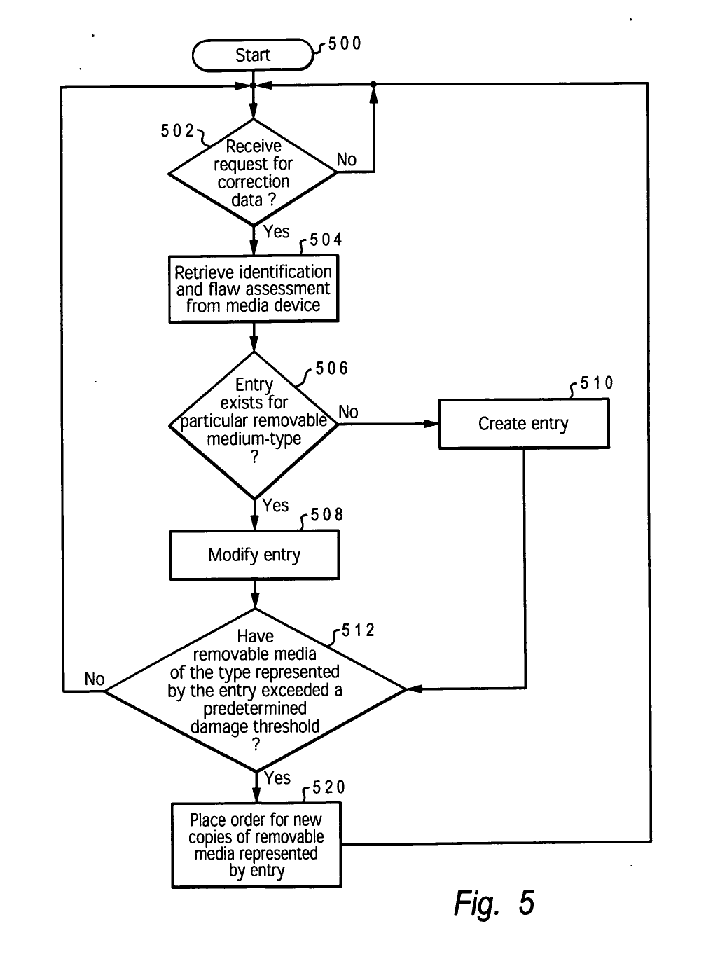

FIG. 5 is a high-level logical flowchart diagram illustrating an exemplary method of controlling removable media inventory according to a preferred embodiment of the present invention. This method of controlling removable media inventory control may enable removable media distributors to ensure the removable media for a predetermined amount of time (e.g., free replacements of removable media for 1-2 years). This replacement policy can be assisted by the method of correcting flawed media data as discussed in conjunction with FIG. 4. The removable media distributors can utilize this method of controlling removable media inventory to measure how individuals handle each removable medium. For example, if a removable medium, such as a DVD, is transferred from person A to person B. Person A does not report a problem with the removable medium, but person B does. It can possibly be inferred that person A has a tendency to handle the removable media roughly. This measure of how people handle removable media can be utilized to set a renting or purchasing price scale. If a first user (such as person A in the previous example) is determined to be one that handles the removable media roughly, that person may be charged a higher rental or handling charge than a normal user.

The process begins at step 500 and proceeds to step 502, which illustrates server 106 determining whether it has received a request for correction data from a media device 102 for a removable medium. If server 106 has not received a request for correction data, the process iterates at step 502. If server 106 has received a request for correction data, the process continues to step 504, which depicts server 106 retrieving identification and flaw assessment data from media device 102 concerning the removable medium. For example, if the removable medium coupled to media device 102 was a DVD, server 106 would want to retrieve the title of the DVD and information concerning the severity of the flaw that prompted the correction data request.

The process continues to step 506, which illustrates processor 302 in server 106 determining whether an entry exists in system memory 306 or hard disk drive 310 for the particular removable medium type. For example, a rental distributor invariably includes multiple copies of a DVD title. The entry may be a database entry of all DVD titles that includes individual DVDs that required correction data for successful processing. If an entry does not exist in memory, the process continues to step 510, which depicts processor 302 creating an entry that represents a class of removable media that the particular removable medium is a member. Processor 302 also indicates the severity of the flaw that prompted the corrective data request. The process then proceeds to step 512.

Returning to step 506, if an entry already exists in memory, the process proceeds to step 508, which illustrates processor 302 modifying the entry to indicate the severity of the flaw that required a corrective data request. The process continues to step 512, which depicts processor 302 determining whether the removable media class of the type represented by the entry has exceeded a predetermined damage threshold. This predetermined damage threshold can be determined by a number of factors including, but not limited to: the number of corrective data requests per particular removable medium, the number of damaged areas on each removable medium, the number of users that have processed the data on each particular removable medium, etc. If processor 302 determines that the removable media class represented by the entry has not exceeded a predetermined threshold, the process returns to step 502 and proceeds in an iterative fashion. If processor 302 determines that the removable media class represented by the entry has exceed a predetermined threshold, the process continues to step 514, which illustrates an order being placed by server 106 for new copies of removable media represented by the entry. The process then returns to step 502 and proceeds in an iterative fashion.

As disclosed, the present invention includes a system and method of utilizing a network to correct flawed media data. The media device includes a processor, a memory, a network adapter, a removable media interface, and error-correction module, and a communication module. The network device enables the media device to connect to the network and server. The removable media interface enables a user to couple a removable medium to the media device. After a user inserts a removable medium into the removable media interface, the processor and error-correction module examines the removable medium for physical errors. If the number of detected errors exceeds a predetermined threshold, the media device, via the network adapter and the communication module, queries a server for correction data. This correction data may be utilized by the media device to enable successful processing of the data stored on the removable medium. In response to a correction data request, the server stores an indication of said correction data request.

In response to a media device retrieving a set of corrective data to be combined with data stored on said removable medium to enable successful processing of said data stored on said removable medium, the server retrieves a set of characteristics including a unique identification of said removable medium. In response to retrieving said set of characteristics, the server stores an indication said removable medium required said retrieving said set of corrective data. This indication can be utilized to control an inventory of removable media. For example, if the removable media that required downloading of correction data has exceeded a predetermined damage threshold, the server can place an order for new copies of the removable media.

In a preferred embodiment of the present invention, the removable medium may be implemented as a digital video disc (DVD). However, those with skill in the art will appreciate that the removable medium may include flash memory, removable disk drives, or any other type of removable media. When the DVD is inserted into a media device (e.g., a DVD player), the media device communicates with a server, which receives several sets of information, that includes, but is not limited to, a confirmation that the user (e.g., renter of the DVD) actually received the DVD, a confirmation that the user is not “subletting” the DVD to another user by checking the IP address of the sending media device and the record of the actual renter of the DVD, and a checksum analysis of the chapters of the DVD.

The server analyzes the checksum data and determines if the DVD is damaged beyond a predetermined damage threshold. If the damage does not exceed the predetermined damage threshold, the server also tracks the quality of the DVD by creating an entry of the database for a class of DVDs (e.g., all DVDs of the same title). If DVDs of a certain class are progressively getting worn down due to their popularity, the server can indicate to a user that replacement DVDs of that class should be ordered to replace the worn DVDs.

Also, by tracking the quality history of DVDs, the server can determine which user of the rental service most likely caused the damage to the DVD. By tracking the quality history of DVDs, the server can assign a score to users of the service based on the whether or not the users are sources of DVD damage due to rough handling, etc. If a particular user is consistently a source of DVD damage, that particular user could be charged an extra damage fee. Likewise, if a user has a history of damage-free handling, that user could be offered a rental discount.

Also, it should be understood that at least some aspects of the present invention may alternatively implemented in a program product. Programs defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A computer-implementable method comprising:
receiving a request from a media device for corrective data to be combined with data stored on a removable medium to enable successful processing of said data stored on said removable medium;
retrieving an identification of said removable medium from said media device;
based on said identification, checking if a database entry exists for a class of removable media for which said removable medium is a member;
when said database entry exists, evaluating if said class of removable media has exceeded a predetermined damage threshold; and
in response to determining said class of removable media has exceeded said predetermined damage threshold, determining a quantity of removable media of said class of removable media for future procurement.

2. The computer-implementable method according to claim 1, further comprising:
assigning a score to a plurality of users with respect to a number of retrievals of corrective data.

3. The computer-implementable method according to claim 1, further comprising:
in response to determining said database entry does not exist, creating said database entry representing said class of removable media.

4. The computer-implementable method according to claim 1, wherein said removable medium is a digital video disc (DVD).

5. The computer-implementable method according to claim 1, wherein said retrieving further includes retrieving a flaw assessment of said removable medium, wherein said flaw assessment is a checksum calculation.

6. The computer-implementable method according to claim 1, further comprising:
guaranteeing performance of said removable medium for a predetermined amount of time.

7. A computer-usable medium embodying computer program code, said computer program code comprising computer executable instructions configured for:
receiving a request from a media device for corrective data to be combined with data stored on a removable medium to enable successful processing of said data stored on said removable medium;
retrieving an identification of said removable medium from said media device;
based on said identification, checking if a database entry exists for a class of removable media for which said removable medium is a member;
when said database entry exists, evaluating if said class of removable media has exceeded a predetermined damage threshold; and
in response to determining said class of removable media has exceeded said predetermined damage threshold, determining a quantity of removable media of said class of removable media for future procurement.

8. The computer-usable medium according to claim 7, wherein said embodied computer program code further comprises computer executable instructions configured for:
assigning a score to a plurality of users with respect to a number of retrievals of corrective data.

9. The computer-usable medium according to claim 7, wherein said embodied computer program code further comprises computer executable instructions configured for:
in response to determining said database entry does not exist, creating said database entry representing said class of removable media.

10. The computer-usable medium according to claim 7, wherein said removable medium is a digital video disc (DVD).

11. The computer-usable medium according to claim 7, wherein said retrieving further includes retrieving a flaw assessment of said removable medium, wherein said flaw assessment is a checksum calculation.

12. The computer-usable medium according to claim 7, further comprising:
guaranteeing performance of said removable medium for a predetermined amount of time.

13. A system comprising:
at least one processing unit;
a data bus coupled to said at least one processing unit;
a memory coupled to said data bus; and
a computer-usable medium embodying computer program code, said computer program code comprising instructions executable by said at least one processing unit and configured for:
receiving a request from a media device for corrective data to be combined with data stored on a removable medium to enable successful processing of said data stored on said removable medium;
retrieving an identification of said removable medium from said media device;
based on said identification, checking if a database entry exists for a class of removable media for which said removable medium is a member;
when said database entry exists, evaluating if said class of removable media has exceeded a predetermined damage threshold; and
in response to determining said class of removable media has exceeded said predetermined damage threshold, determining a quantity of removable media of said class of removable media for future procurement.

14. The system according to claim 13, wherein said instructions are further configured for:
assigning a score to a plurality of users with respect to a number of retrievals of corrective data.

15. The system according to claim 13, wherein said instructions are further configured for:
in response to determining said database entry does not exist, creating said database entry representing said class of removable media.

16. The system according to claim 13, wherein said removable medium is a digital video disc (DVD).

17. The system according to claim 13, wherein said retrieving further includes retrieving a flaw assessment of said removable medium, wherein said flaw assessment is a checksum calculation.

18. The system according to claim 13, wherein said instructions are further configured for:
guaranteeing performance of said removable medium for a predetermined amount of time.
